(19) United States
(12) Patent Application Publication
(10) Pub. No.: US 2013/0183518 A1
(43) Pub. Date: Jul. 18, 2013

(54) ENERGY SAVING GLASS AND A METHOD FOR MAKING ENERGY SAVING GLASS

(71) Applicants: Markku Rajala, Vantaa (FI); Joe Pimenoff, Helsinki (FI); Daniel Decroupet, Fosses-la-Ville (BE)

(72) Inventors: Markku Rajala, Vantaa (FI); Joe Pimenoff, Helsinki (FI); Daniel Decroupet, Fosses-la-Ville (BE)

(73) Assignee: Beneq Oy, Vantaa (FI)

(21) Appl. No.: 12/597,068

(22) PCT Filed: Apr. 21, 2008
(86) PCT No.: PCT/FI08/50209

§ 371 Date: Mar. 10, 2010

(30) Foreign Application Priority Data
Apr. 23, 2007 (FI) 20070320

(51) Int. Cl. C03C 21/00

(52) U.S. Cl. CPC C03C 21/008
USPC 428/336; 428/426; 428/432; 65/60.1; 65/60.4; 65/60.2

(57) ABSTRACT

The energy saving glass comprises a substantially mutually parallel first surface and second surface, and the glass mass of the energy saving glass contains a solar radiation energy absorbing agent. The solar radiation energy absorbing agent is present in a layer of the glass mass which is close to the first surface, in which layer the concentration of the radiation energy absorbing agent substantially decreases when proceeding from the first surface deeper into the glass mass, such that the absorbing agent is present at the depth of at least 0.1 micrometres and not more than 100 micrometres as measured from the first surface of the glass. In the method, a layer of particulates is grown on the first surface of the glass, which particulates include at least one element or compound of the elements and diffuse and/or dissolve into the surface layer of the glass. At least one element dissolving from the particulates modifies the surface layer of the glass such that the solar radiation energy absorbing layer is formed on the surface, in which layer the concentration of said at least one element substantially decreases from the surface of the glass deeper into the glass, such that the element is present at the depth of at least 0.1 micrometres and not more than 100 micrometres as measured from the surface of the glass.

### FIELD OF THE INVENTION

The invention relates to the energy saving glass defined in the preamble of claim 1. Furthermore, the invention relates to the method defined in the preamble of claim 17.

### BACKGROUND OF THE INVENTION

When solar radiation energy meets a glass surface, some of the radiation is reflected, some of it is absorbed into the glass and some of it penetrates the glass. In a normal window glass, the absorption is scarce. The solar radiation that penetrates the window is absorbed into the surfaces and objects in the interior of the building, which warm and release the heat further into the interior. In areas with a high degree of solar radiation, the heat causes the need for cooling the room areas. Buildings are great energy-consumers, for example in the North America, heating, cooling and lighting of buildings make up 30-40% of all energy. Therefore technical solutions which reduce the need for cooling and heating buildings, and windows which bring as much natural light into the buildings as possible are economically extremely valuable. Only about half of the solar radiation energy is in the visible wavelength range, so ideally, filtering the ultraviolet (uv) and (near) infrared range (IR) would remove half of the thermal load provided by the sun, without nevertheless reducing the amount of visible light.

A considerably greater amount of solar radiation is absorbed into a glass which contains nonferrous metal oxides, such as transition metal oxides. Most typically, such glasses are grey, bronze, blue, green or combinations of these colours. A grey glass transmits visible light and infrared radiation nearly equally, a bronze glass transmits less visible light and more IR radiation than the grey glass, and blue and green glasses transmit more visible light and less IR light than the grey glass. Also agents that absorb uv-radiation can be added to the glass, such as titanium dioxide or vanadium pentoxide, which absorb uv-radiation without absorbing to any considerable degree radiation in the visible wavelength range.

However, colouring the glass mass with nonferrous metal oxides is not a very good way of producing energy glasses. In areas where there is not too much of the solar radiation energy (heating-oriented climates), glasses should be as clear as possible. Similarly in solutions in which the window has two or more glasses, only the outer glass should be a solar radiation absorbing glass. If the entire glass mass is coloured, the glass mass in the glass-melting furnace of a flat glass production line must be regularly changed into clear/coloured glass mass, and changing the colour increases the expenses considerably in flat glass production.

U.S. Pat. No. 3,473,944 discloses a radiation-reflecting material in which a glass sheet is coated on opposite surfaces with tin oxide doped with antimony oxide such that the surface of the glass facing the exterior contains 25-35.5% antimony and the surface of the glass facing the interior contains 2.2-6.4% antimony. In this case, the inner surface of the window reflects heat radiation from the room area back to the room area and the outer surface of the window absorbs solar radiation. The outer coating causes the glass to be greyish in colour. The coating is produced on the surface of the glass by chemical vapour deposition (CVD).

The problem with this glass is that a sufficiently thick absorption layer cannot be produced at the flat glass production rate. In a flat glass production process, the glass ribbon proceeds at the rate of 10-20 m/min. The growth rate provided by CVD process is typically less than 100 nm/s, so the time available for the coating unit (1−2s) does not allow a sufficiently thick layer from the standpoint of the absorption. Another problem with this solution is that with a thick absorption layer, transmission of the visible light in the glass is considerably reduced.

U.S. Pat. No. 3,652,256 discloses a device for coating a hot glass ribbon in conjunction with the glass production process. With the device, it is possible to produce a solar energy absorbing coating on the surface of the glass or change in some other manner the transmission of light through the glass. In the device, coating the glass is based on applying spray pyrolysis on the surface of the glass. The problem with this device and method is that the metal oxide layer produced by the spray-pyrolysis method on the surface of the glass dissolves and diffuses quite slowly into the glass. The patent publication states that the thickness of the coloured layer is about 50 nm. In order to provide a sufficient absorption/colour for such a short distance, there must be a separate antimony-doped tin oxide layer on the surface of the glass, which is only partly dissolved into the glass. This provides problems for the long-term endurance, wash resistance and corresponding mechanical and chemical wearing of the coating.

U.S. Pat. No. 5,721,054 discloses a glass structure realized with a pyrolytic coating (high temperature CVD) in which a solar radiation absorbing layer that contains chromium, cobalt and iron, and a non-absorbent layer for making the appearance of the glass more appealing are produced in the glass. According to the method, the thickness of the absorbing layer is most preferably 40-75 nm.

The problem with the method disclosed in the above-mentioned patent is that there are no source materials for these absorbing materials which would by themselves function as flocculent source materials in CVD deposition, so the source materials have to be supplied to the process by means of the high temperature technique described in the patent at the temperature of about 600° C., which requires expensive equipment and expensive operation costs. A further problem with the method is that the oxides mainly appear as a separate coating on the surface of the glass. The thickness of the material should therefore be low so that the oxide layer would not absorb visible light to a disturbing degree.

U.S. Pat. No. 6,048,621 discloses an energy glass comprising successive solar energy absorption and low emissivity layers. The problem with the structure is that solar radiation energy is absorbed into the glass surface close to the room area, such that the heat transferring by convection from the warm glass is mainly transferred into the room, so the structure does not provide any considerable saving of the cooling energy.

Solar radiation energy absorbing into the glass increases the glass temperature. A glass that is warmer than its surroundings causes air to flow past the surface of the glass. The heat transfers convectively from the glass to the air flow. If the glass absorbs radiation energy throughout, it warms evenly and the ratio of the heat quantities transferring convectively to different sides of the glass depends on the ambient temperature. In other words, if the room area is cooled mechanically, more heat transfers from the glass into the interior than into the (warmer) exterior of the building, in which case a large portion of the solar energy absorbing effect of the glass is lost (in view of the cooling requirement). A more preferred solution is achieved when the absorption takes place on the outer surface of the glass, in which case the resistance for the heat transfer produced by conduction of the heat through the glass substantially reduces the thermal load transferring into the interior.

The absorption layer on the outer surface of the glass must be extremely resistant against effects of the ambient conditions, such as chemical and mechanical wearing. The absorption layer provides a temperature difference into the glass, so the absorption layer should most preferably be such that the absorption decreases gradually as a function of the thickness of the glass, so that any sharp temperature differences will not be formed into the glass. Such sharp differences provide harmful tensions into the glass. In particular when using the glass in locations where the glass surface does not warm evenly by the effect of the solar radiation (due to shadows caused on the surface of the glass for example by the surrounding buildings or trees) also temperature differences parallel to the surface may appear in the glass.

Thus, there is a need for an energy saving glass in which the glass composition on the outer surface of the glass is so modified that the outer surface of the glass (and not a separate coating on the surface of the glass) absorbs solar radiation, most preferably solar uv- and near-IR-radiation over a short distance in the surface layer of the glass, and that the absorption of the radiation decreases as the radiation penetrates deeper into the glass.

Furthermore, from the standpoint of energy efficiency it is desirable that in some application sites the opposite surface of the glass is coated with a low emissivity coating, and for the cost-effectiveness of the process it is substantial that such coating can be accomplished in the same process as the production of the solar radiation absorbing layer.

Combining a low emissivity surface with a solar radiation absorbing glass is important in areas in which both cooling and heating are required. In these areas, single glazed windows are commonly used, and replacing them with double glazed solutions (separate absorption and low emissivity glasses) is often too expensive a solution.

Furthermore, there is a need to transfer the energy absorbing into the surface of the glass away from the glass as efficiently as possible, to which end the glass surface may separately be made hydrophilic, so that the possible water raining/sprayed on the surface spreads efficiently over the surface of the glass and removes the heat from the surface of the glass as it runs down the surface. It is preferred for the cost-effectiveness of the process that the hydrophilic coating could be produced in the same process as the production of the other layers.

### OBJECTIVE OF THE INVENTION

The objective of the invention is to eliminate the drawbacks referred to above.

One specific objective of the invention is to disclose an energy saving glass suitable for reducing energy consumption in areas in which cooling the buildings (air conditioning) causes considerable energy consumption, and in areas in which both heating and cooling are used in buildings.

A further objective of the invention is to disclose an energy saving glass suitable for use in locations where the window comprises a single glass pane.

A further objective of the invention is to disclose a method for making an energy saving glass in which the solar energy absorbs into a layer as thin as possible on the surface of the glass facing the outdoor air.

### SUMMARY OF THE INVENTION

The energy saving glass according to the invention is characterized by what has been presented in claim 1. The method according to the invention is characterized by what has been presented in claim 17.

According to the invention, the energy saving glass comprises a solar radiation energy absorbing agent in a layer of the glass mass which is close to a first surface of the glass, in which layer the concentration of the radiation energy absorbing agent substantially decreases when proceeding from the first surface deeper into the glass mass, such that the absorbing agent is present at the depth of at least 0.1 micrometres and not more than 100 micrometres as measured from the first surface of the glass.

According to the invention, a layer of particulates is grown in the method on the first surface of the glass, the particulates comprising at least one element or compound of the elements and diffuse and/or dissolve into the surface layer of the glass, so that at least one element dissolving from the particulates modifies the surface layer of the glass such that the solar radiation energy absorbing layer is formed on the surface, in which layer the concentration of said at least one element substantially decreases from the surface of the glass deeper into the glass such that the element is present at the depth of at least 0.1 micrometres and not more than 10 micrometres as measured from the surface of the glass.

In other words, the energy saving glass is provided by growing a material of particulates on the surface of a flat glass during its manufacture or processing, which material substantially comprises metals or their compounds, particularly metal oxides, which provide during their dissolution into the glass a modification in the glass, so that the glass will absorb solar radiation. In this manner, the surface of the glass is modified into a different type of glass, substantially without any coating present on the surface. The nanoparticles may contain, in the same or different particles, various different metals or their compounds which produce, as they dissolve into the glass, a glass material absorbing solar radiation at a specific wavelength range. The nanoparticles diffuse or dissolve into the glass such that a greater amount of this metal dissolves on the surface of the glass, and the concentration of the dissolved metal decreases in the direction of the depth of the glass. The concentration of the solar radiation absorbing metal in the energy saving glass therefore decreases in the direction of the depth of the glass. Altogether, the glass comprises solar radiation absorbing metal at the depth that may range from 0.1 micrometres to 100 micrometres, depending on the processing temperature and time of the glass.

As a window glass of a building, the energy saving glass reduces the energy consumption of buildings in areas in which cooling (air conditioning) of buildings leads to considerable energy consumption and in areas in which both heating and cooling are used in buildings. The energy saving glass is particularly preferably used in locations where the window comprises a single glass pane.

Providing an efficient energy saving glass requires the absorption of the solar energy into a layer which is as thin as possible on the surface of the glass facing the exterior. By the method according to the invention, the flat glass is provided, in conjunction with its manufacture or processing, a surface in which the solar energy absorbing agents are grown on the surface of the glass preferably as nano-sized particles, from which particles these agents dissolve and/or diffuse into the surface layer of the glass. The method according to the invention further allows in the same process the production of a low emissivity coating on the opposite surface of the glass.

In order to make the metal included in the nanoparticles dissolve gradually into the glass, i.e. such that the concentration of the dissolved metal decreases in the direction of the depth of the glass, it is substantial to warm the glass such that the surface of the glass warms more than the interior of the glass. In this manner, the glass will have low viscosity on the surface of the glass, and the viscosity increases in the direction of the depth of the glass, providing greater diffusion of the metal on the surface of the glass than deeper in the glass. Warming of the glass is in this case preferably made convectively, because warming the glass by means of heat transfer by radiation would provide a relatively even absorption of heat energy over the entire depth of the glass, in which case the entire glass object would substantially warm in the same manner. It has been observed in the present invention that it is preferred to let the flame of a liquid flame spray pistol used in the production of nanoparticles warm the surface of the glass, so that the same process provides two preferable effects, namely the production of nanoparticles and convective heating of the glass surface.

In the same process, it is possible to grow on the surface of the energy saving glass that is opposite to the solar radiation absorbing surface a low emissivity coating which may typically be a coating having a thickness of 200-900 nm and in which the material may be fluorine-doped tin oxide or aluminium-doped zinc oxide.

It is possible to grow on the solar radiation absorbing surface of the energy saving glass a coating that modifies the surface to be hydrophilic, for example a nanothick (less than 100 nm) titanium dioxide coating that covers at least part of the surface, and most preferably a titanium dioxide coating in which the crystalline form is anatase. By the effect of ultraviolet radiation, this coating modifies the surface to be hydrophilic, so that the water brought onto the surface spreads in an even layer over the surface. In this manner, heat in the glass is efficiently transferred into the water. Preferably, the titanium dioxide coating also operates as a solar ultraviolet radiation absorbing material without absorbing the visible light to a considerable degree.

There may thus be different variations of the energy saving glasses according to the invention:
an energy saving glass in which the surface facing the exterior comprises a gradually modified glass composition, such that the absorption of solar radiation is strongest on the surface of the glass and the absorption decreases gradually to the degree of absorption of a basic glass over a distance of 0.1-100 micrometres
the above-described glass in which the surface opposite to the solar radiation absorbing surface is coated with a low emissivity coating, typically so that it is produced in the same process as the radiation absorbing surface
the above-described glass in which the solar radiation absorbing surface is so coated that the surface is hydrophilic in itself or becomes hydrophilic by the effect of ultraviolet radiation
an energy saving glass in which the surface facing the exterior comprises a gradually modified glass composition, such that solar radiation absorption is strongest on the surface of the glass and the absorption decreases gradually to the degree of absorption of a basic glass over a distance of 0.1-100 micrometres, and in which the solar radiation absorbing surface is so coated that the surface is hydrophilic in itself or becomes hydrophilic by the effect of ultraviolet radiation

The energy saving glass according to the invention is therefore not based on a separate metal oxide layer on the surface of the glass, but on modifying the surface layer of the glass such that the surface layer will absorb solar radiation. It has been observed in the tests that such a modified glass can be tempered in a conventional glass tempering process. This type of tempered glass, a glass that absorbs solar radiation into the surface layer, can be preferably used in locations where temperature differences parallel to the surface occur on the surface of the glass, for example due to shadows falling on the surface of the glass. In such locations, tempering of the glass may substantially reduce the risk of breaking resulting from the temperature differences in the glass.

The energy saving glass according to the invention can most preferably be produced by liquid flame spraying method or laser ablation method, or by combining these together or by combining both or one of them with chemical vapour deposition.

### LIST OF FIGURES

In the following section, the invention will be described in detail by means of exemplary embodiments with reference to the accompanying drawing in which

FIG. 1 shows a cross-section of one embodiment of the energy saving glass according to the invention,

FIG. 2 shows the heat transfer in one embodiment of the energy saving glass according to the invention,

FIG. 3 shows the concentration of a solar radiation absorbing metal as a function of glass depth in one energy saving glass according to the invention,

FIG. 4 shows a method for making the energy saving glass according to the invention,

FIG. 5 shows a method for making the energy saving glass according to the invention, the glass comprising a low emissivity coating; and

FIG. 6 shows a method for making the energy saving glass according to the invention, the glass comprising a coating that makes the surface of the glass hydrophilic.

### DETAILED DESCRIPTION OF THE INVENTION

The invention relates to an energy saving glass in which the surface layer of the glass is modified such that the concentration of a radiation energy absorbing agent substantially decreases in the surface layer of the glass over a distance of 0.1-100 micrometres. The layer of the glass is not a separate coating on the surface of the glass but a layer provided by modifying the glass composition, which composition changes gradually so that over a distance of 0.1-100 micrometres the composition of the surface layer changes into a basic glass composition. This type of layer absorbs solar radiation such that the surface absorbs radiation the most and the absorption decreases gradually as the radiation penetrates deeper into the glass. This produces a situation where the surface layer of the glass warms the most, so that heat is transferred from the surface layer of the glass by convection (into air) or by conduction (into water). The gradual warming evens out the temperature difference between the surface layer and the basic glass so that no significant tensions caused by the temperature difference are formed between the surface and the basic glass.

The absorption of solar radiation is provided by doping into the glass at least one of the following elements: Al, Se, Ti, V, Cr, Mn, Fe, Co, Ni, Cu, Zn, Ge, Sr, Zr, Nb, Mo, Te, Ag, Sn, Sb, Au, Pr, Nd, Pm, Sm, Eu, Gd, Tb, Dy, Ho, Er, Tm, Yb, Lu, U.

The energy saving glass according to the invention can be realized by preparing a solution from a soluble compound of at least one of the above-mentioned metals, feeding the solution for example through the liquid flame spraying apparatus mentioned in Finnish patent FI98832, so that nanoparticles of said metal or nanoparticles of a metal oxide are formed from the liquid source material. These particles are led to the surface of the glass, the surface of the glass being at the temperature of more than 500° C., so that the particles diffuse and/or dissolve into the glass such that the metal concentration is highest on the surface of the glass and decreases gradually deeper in the glass. The metal dissolves and/or diffuses typically up to the depth of 0.1-100 micrometres. The manufacture method can be integrated into a glass production line (float line), so that the energy saving glass can be produced at the flat glass production rate. The manufacture method can also be integrated into a glass processing line in which the glass is heated, such as a glass tempering or bending line. The energy saving glass can also be produced in a separate off-line apparatus in which the glass is heated separately so that modifying the glass surface in the above-described manner becomes possible.

The surface of the energy saving glass according to the invention that is opposite to the solar radiation absorbing surface can be coated with a conductive oxide coating, for example tin oxide doped with fluorine (SnO₂:F) or zinc oxide doped with aluminium (ZnO:Al), so that the energy saving characteristics of the glass can be improved such that heat radiation from the interior of the building will not be able to radiate out through the window (low emissivity, i.e. low-E coating). Such glass structure is applicable in areas in which buildings need to be both cooled and heated and in which the window structure is single glazed.

The solar radiation absorbing surface of the energy saving glass according to the invention can further be entirely or partly coated with nano-sized titanium dioxide particles which modify the glass surface to be hydrophilic by the effect of sunlight. In this case, water that hits the surface of the glass spreads into an even layer of water on the surface of the glass and runs down the surface, so that an efficient heat transfer is provided from the surface of the glass into the water.

In the following section, the invention will be described in more detail with examples.

### EXAMPLES

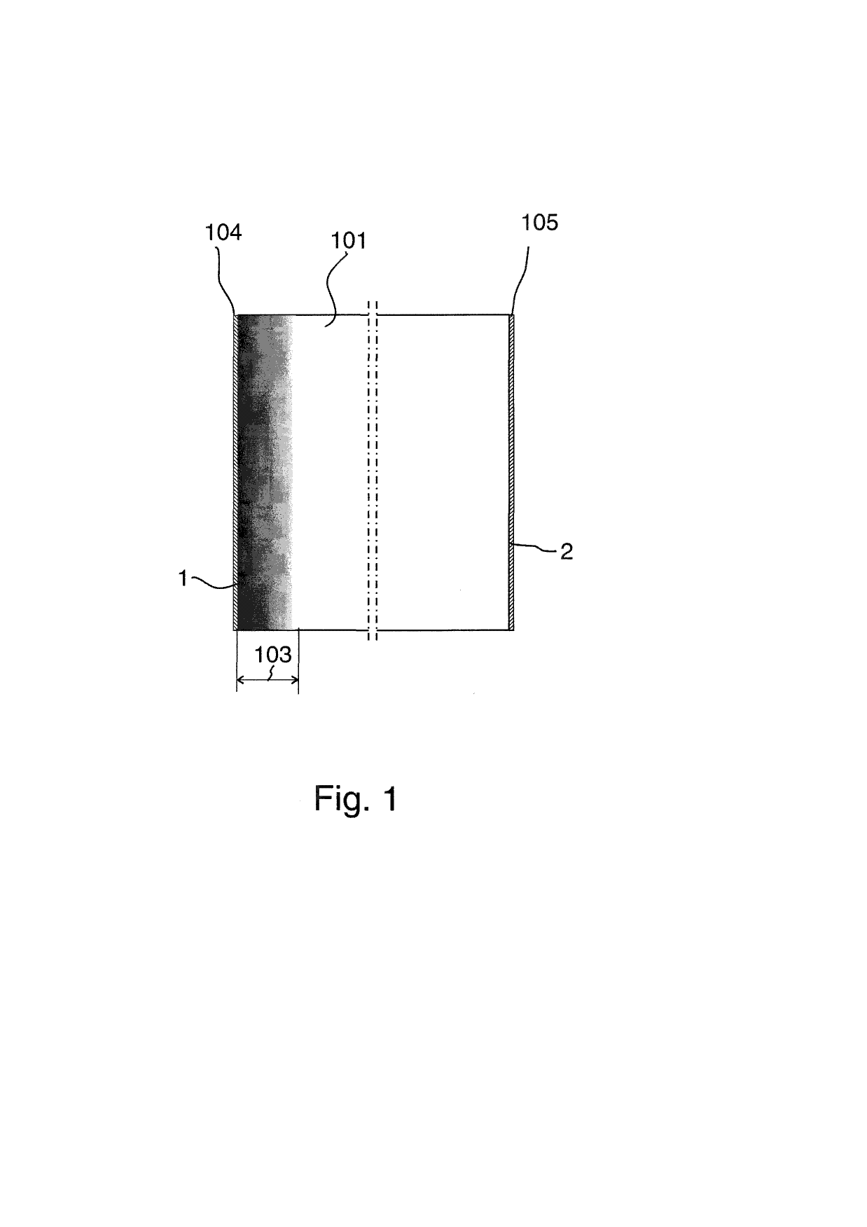

FIG. 1 shows the energy saving glass according to the invention. A layer of material 104 has been grown on the outer surface 1 of the glass by means of nanoparticles, from which layer the material diffuses and/or dissolves into the glass mass 101, providing an area 103 which is 0.1-100 micrometres deep and in which the metal oxide concentration of the glass gradually decreases when proceeding from the surface 1 deeper into the glass, which is illustrated in FIG. 1 as the area shifting from dark to white. This gradual layer 103 provides at least partial absorption of solar energy into the surface layer of the glass. It is possible to grow a low emissivity coating 105 on the inner surface 2 of the glass 101, or coat the glass before growing the absorption layer with such coating, which may be for example a coating made from Transparent Conductive Oxide (TCO).

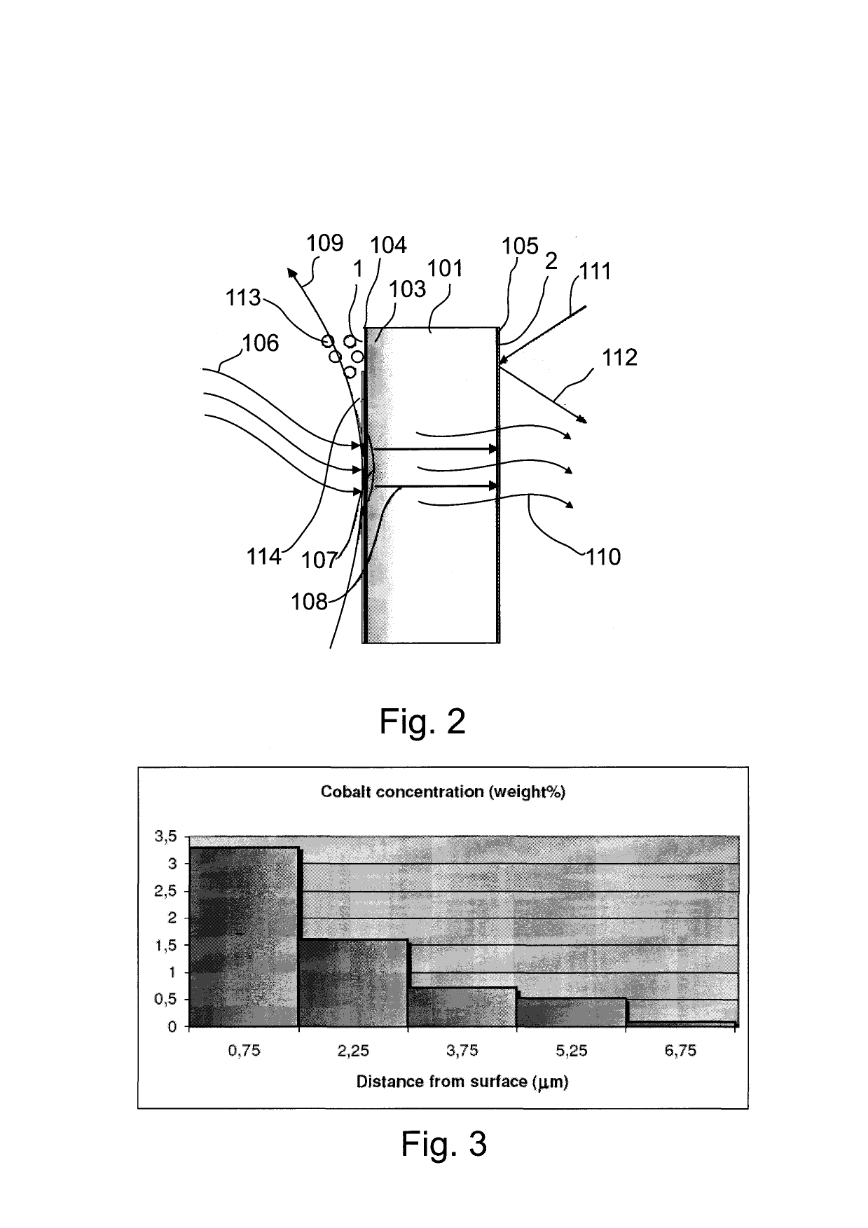

FIG. 2 shows the behaviour of the energy saving glass of FIG. 1. Energy 106 from the sun is absorbed at least partly into the surface layers 103 and 104 of the glass. The materials of the surface layer are preferably selected so that the absorption of the radiation is higher in the ultraviolet (uv) and near infrared (NIR) range of the radiation than in the range of visible light. Energy absorbed into the surface of the glass provides warming of the glass in the surface layer 107 of the glass. Warming of the surface produces convective heat transfer 109 from the glass into the air. This convective heat transfer 109 is preferably at least of the same order as the conductive heat transfer 108 passing through the glass. The radiation energy 110 transferring into the interior of the building provides warming of the interior, so that the interior emits heat radiation 111 towards the glass. The wavelength of this heat radiation 111 is substantially greater than the wavelength of the radiation energy 110, so that the low emissivity coating 105 on the inner surface of the glass provides reflection 112 of the heat radiation back into the interior. The surface layer 104 of the glass may be hydrophilic or superhydrophilic so that water vapour or water droplets 113 condensed or otherwise accumulated on the surface form an even film of water 114 on the surface, which film cools the outer surface 1 of the glass as it runs down due to the effect of gravity.

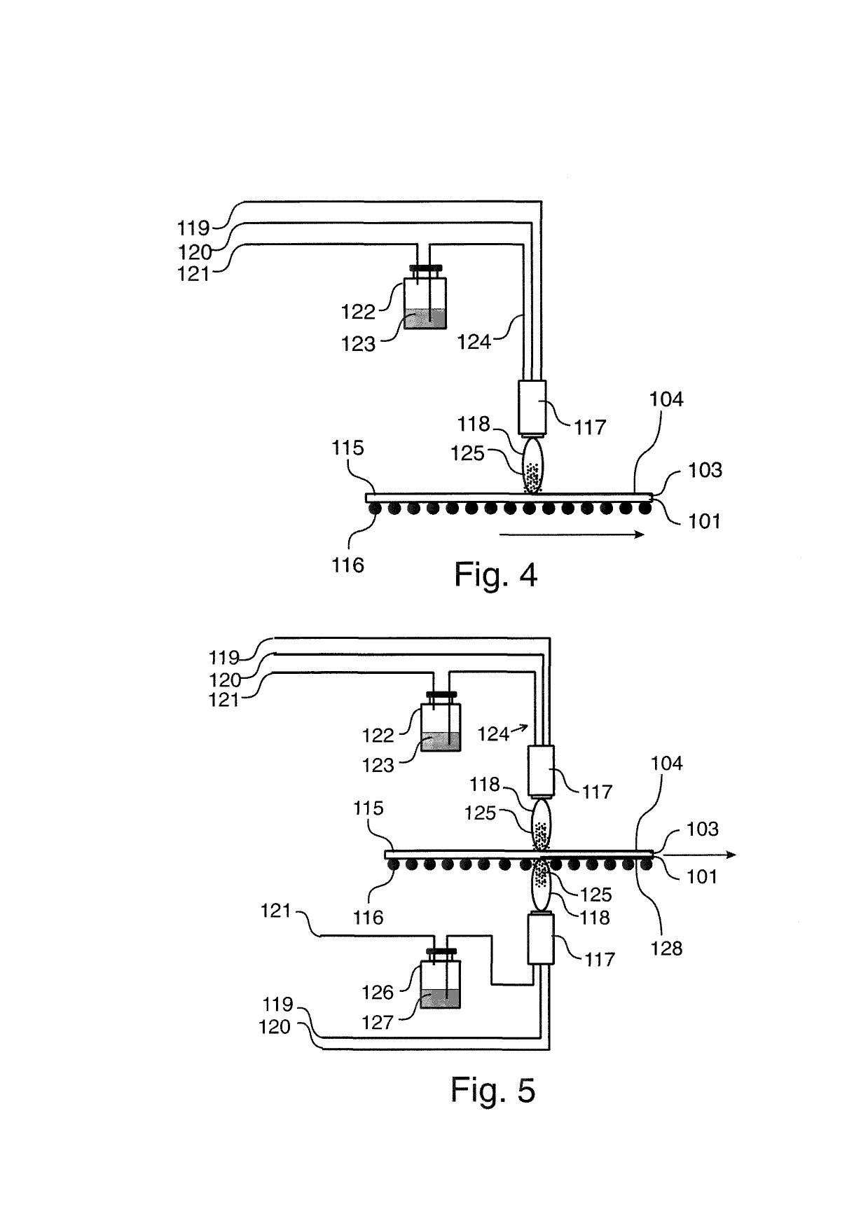

FIG. 4 shows a method for making the energy saving glass according to the invention. The glass 115 passes on driving rollers 116 for example on a glass production line (float line) or in glass processing, such as tempering of the glass. A hydrogen-oxygen flame 118 is produced with a flame spray pistol 117 by feeding hydrogen from duct 119 and oxygen from duct 120 into the spray pistol 117. Pressurisation gas is further led from duct 121 into a container 122, effecting on the mixture 123 of metal nitrate and alcohol in the container to pass along a feeding duct 124 to the spray pistol 117. The mixture of metal nitrate and alcohol 123 reacts in the hydrogen-oxygen flame 118 such that it forms particulates 125. The aerodynamic diameter of the particulates 125 may vary in the range of 0.01-10 micrometres, preferably being less than 1 micrometre and most preferably less than 0.1 micrometres. The hydrogen-oxygen flame 118 warms the surface 115 of the glass convectively. The particulates 125 drift to the surface of the glass 115, forming a layer 104 from which the material of the particulates diffuses and/or dissolves at least partly further into the glass 115, forming a gradual layer 103 which functions as the radiation energy absorbing layer of the energy saving glass 101.

FIG. 5 shows a method for making the energy saving glass according to the invention, in which a low emissivity layer 128 is provided at the same time on the other surface of the glass. The glass 115 passes on the driving rollers 116 for example on glass production line (float line) or in glass processing, such as glass tempering. The hydrogen-oxygen flame 118 is provided by the flame spray pistol 117 by feeding hydrogen from duct 119 and oxygen from duct 120 into the spray pistol 117. Pressurization gas is further led from duct 121 to the container 122, effecting on the mixture 123 of metal nitrate and alcohol in the container to pass along the feeding duct 124 to the spray pistol 117. The mixture of metal nitrate and alcohol 123 reacts in the hydrogen-oxygen flame 118 so that it forms particulates 125. The aerodynamic diameter of the particulates 125 may vary in the range of 0.01-10 micrometres, preferably being less than 1 micrometre and most preferably less than 0.1 micrometres. The particulates 125 drift to the surface of the glass 115, forming the layer 104 from which the material of the particulates diffuses and/or dissolves at least partly further into the glass 115, forming the gradual layer 103 which functions as the radiation energy absorbing layer of the energy saving glass 101. Hydrogen and oxygen are further led into another spray pistol 117 disposed on the other side of the glass 115 for providing a hydrogen-oxygen flame, and also a compound comprising tin and fluorine is led to the spray pistol, the compound being for example a mixture 127 of mono-butyl tin chloride, fluorohydric acid, water and alcohol, which produces particles 125 containing fluorine-doped tin oxide and is used for growing the low emissivity coating 128 on the lower surface of the glass 115.

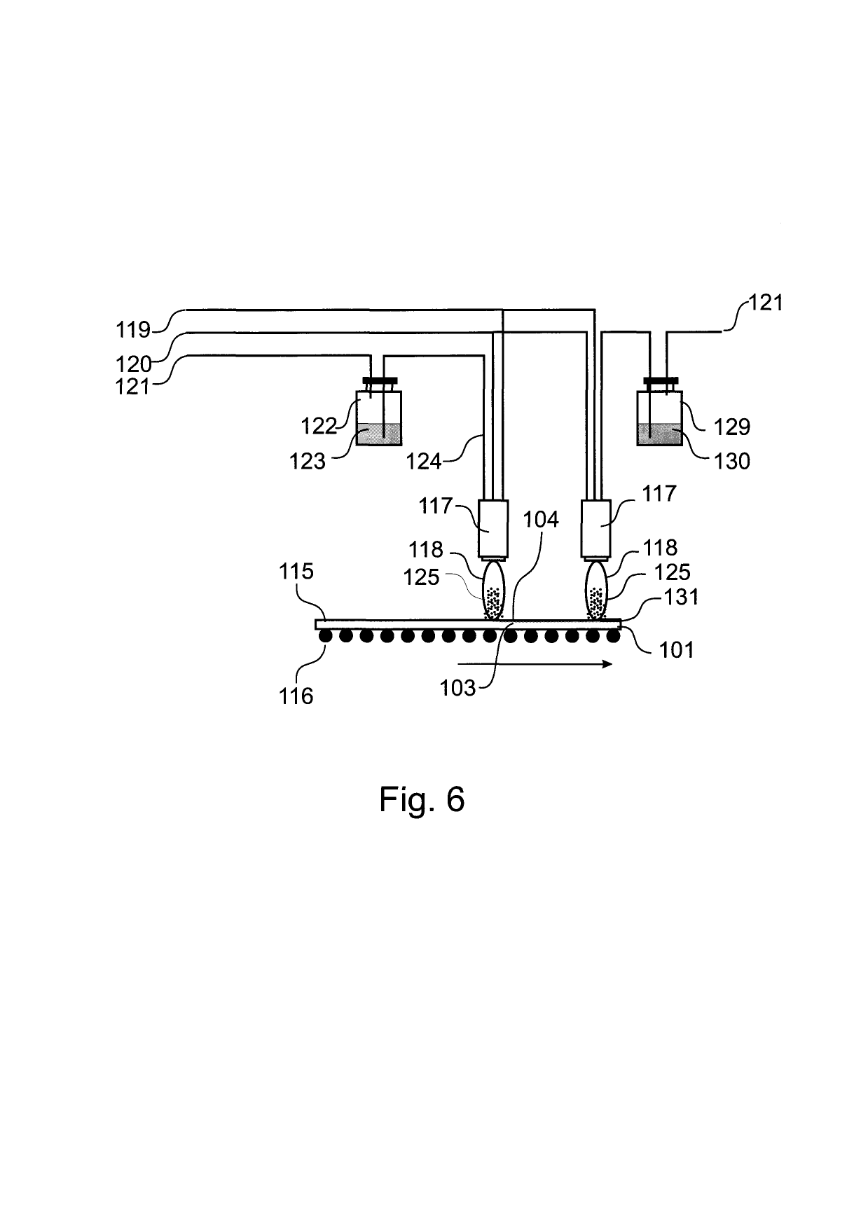

FIG. 6 shows a method for making the energy saving glass according to the invention, in which a hydrophilic surface is provided on the surface of the glass in the same process. The glass 115 passes on the driving rollers 116 for example on glass production line (float line) or in glass processing, such as tempering of the glass. The hydrogen-oxygen flame 118 is provided by the flame spray pistol 117 by feeding hydrogen from duct 119 and oxygen from duct 120 into the spray pistol 117. Pressurization gas is further led from duct 121 to the container 122, effecting on the mixture 123 of metal nitrate and alcohol in the container to pass along the feeding duct 124 to the spray pistol 117. The mixture 123 of metal nitrate and alcohol reacts in the hydrogen-oxygen flame 118 such that it forms particulates 125. The aerodynamic diameter of the particulates 125 may vary in the range of 0.01-10 micrometres, preferably being less than 1 micrometre and most preferably less than 0.1 micrometres. The particulates 125 drift to the surface of the glass 115, forming the layer 104 from which the material of the particulates diffuses and/or dissolves at least partly further into the glass 115, forming the gradual layer 103 which functions as the radiation energy absorbing layer of the energy saving glass 101. Besides the mixture of hydrogen and oxygen 120/121, a titanium compound 130 is further led to another spray pistol 117, with the result that the particulates produced in the hydrogen-oxygen flame 118 also comprise titanium dioxide, so that a titanium dioxide containing coating 131 is provided on the surface of the glass, forming the hydrophilic coating on the surface of the energy saving glass 101 when being exposed to ultraviolet radiation. Thanks to the hydrophilic coating, the surface of the glass spreads any water that may hit it into an even film of water, so that the heat absorbed into the surface of the glass is efficiently transferred into the water.

There may be embodiments which differ from the embodiments presented in the figures for making the energy saving glass. Similarly, the structure of the exemplary embodiments of the invention may vary in accordance with the spirit of the invention. Consequently, the number and order of the spray pistols may differ from the embodiments mentioned above, and instead of the flame spray pistol, the method for producing the particulates may be for example a CVO process, a laser ablation process or the like. Therefore, the embodiments of the invention presented herein are not to be interpreted in the sense of limiting the invention; instead, many variations are possible within the scope of the inventive features presented in the subsequent claims.

1. An energy saving glass comprising a substantially mutually parallel first surface (1) and second surface (2), in which energy saving glass the glass mass (101) contains a solar radiation energy absorbing agent, characterized in that the solar radiation energy absorbing agent in present in a layer (103) of the glass mass (101) which is close to the first surface (1), in which layer the concentration of the radiation energy absorbing agent substantially decreases when proceeding from the first surface (1) deeper into the glass mass, such that the absorbing agent is present at the depth of at least 0.1 micrometres and not more than 100 micrometres as measured from the first surface (1) of the glass.

2. The energy saving glass according to claim 1, characterized in that the solar radiation absorbing agent is formed by doping one or more of the following elements:
Al, Se, Ti, V, Cr, Mn, Fe, Co, Ni, Cu, Zn, Ge, Sr, Zr, Nb, Mo, Te, Ag, Sn, Sb, Au, Pr, Nd, Pm, Sm, Eu, Gd, Tb, Dy, Ho, Er, Tm, Yb, Lu, U, and/or of the compounds of these elements into the layer (103) of the glass mass (101) which is close to the first surface (1).

3. The energy saving glass according to claim 1 or 2, characterized in that the solar radiation absorbing agent is selected to absorb mainly solar ultraviolet and near infrared radiation.

4. The energy saving glass according to any one of claims 1 to 3, characterized in that the solar radiation energy absorbing agent is diffused and/or dissolved into the glass mass (101).

5. The energy saving glass according to any one of claims 1 to 4, characterized in that the solar radiation energy absorbing agent is supplied into the glass mass (101) as particulates, preferably nanoparticles, as the surface of the glass is heated to the temperature of more than 500° C.

6. The energy saving glass according to any one of claims 1 to 5, characterized in that the first surface (1) is coated with a coating (131) that is hydrophilic or becomes hydrophilic due to the effect of solar ultraviolet radiation.

7. The energy saving glass according to claim 8, characterized in that the coating (131) is titanium oxide and the thickness of the coating is in the order of less than 100nm.

9. The energy saving glass according to claim 8, characterized in that the crystalline form of the titanium oxide in the coating (131) is anatase.

10. The energy saving glass according to any one of claims 1 to 9, characterized in that the second surface (2) is coated with a low emissivity coating (105, 128) (low-E coating).

11. The energy saving glass according to claim 10, characterized in that the low emissivity coating (105, 128) is a coating formed of transparent conductive oxide.

12. The energy saving glass according to claim 10 or 11, characterized in that the low emissivity coating (105, 128) is fluorine-doped tin oxide (SnO₂:F).

13. The energy saving glass according to claim 10 or 11, characterized in that the low emissivity coating (105, 128) is aluminium-doped zinc oxide (ZnO:Al).

14. The energy saving glass according to any one of claims 1 to 13, characterized in that the energy saving glass is a glass in a single glazed window of a building, in which glass the first surface (1) is the outer surface facing the open exterior and the second surface (2) is the inner surface facing the interior of the building.

15. The energy saving glass according to any one of claims 1 to 14, characterized in that the glass is tempered.

16. Use of the energy saving glass according to any of claims 1 to 15 as a window glass of a building.

17. A method for making an energy saving glass, in which method a solar radiation energy absorbing agent is arranged into the glass mass at an increased temperature of the glass mass, characterized in that a layer (104) of particulates is grown on a first surface (1) of the glass, which particulates comprise at least one element or compound of the elements and diffuse and/or dissolve into the surface layer of the glass, so that at least one element dissolving from the particulates modifies the surface layer of the glass such that a solar radiation energy absorbing layer (103) is formed on the surface, in which layer the concentration of said at least one element substantially decreases from the surface of the glass deeper into the glass, such that the element is present at the depth of at least 0.1 micrometres and not more than 100 micrometres as measured from the surface of the glass.

18. The method according to claim 17, characterized in that said layer (104) of particulates is grown on the first surface (1) of the glass, which particulates include at least one element of the following:
Al, Se, Ti, V, Cr, Mn, Fe, Co, Ni, Cu, Zn, Ge, Sr, Zr, Nb, Mo, Te, Ag, Sn, Sb, Au, Pr, Nd, Pm, Sm, Eu, Gd, Tb, Dy, Ho, Er, Tm, Yb, Lu, U, and/or the compounds of these elements.

19. The method according to claim 17, characterized in that the aerodynamic diameter of the particulates grown on the first surface (1) of the glass is in the range of 0.01-10 micrometres, preferably less than 1 micrometre, most preferably less than 0.1 micrometres.

20. The method according to any one of claims 17 to 19, characterized in that in the method, the first surface (1) of the glass is heated to the temperature of more than 500° C., such that the first surface of the glass warms more than the interior of the glass.

21. The method according to any one of claims 17 to 20, characterized in that the first surface (1) of the glass is heated convectively.

22. The method according to any one claims 17 to 21, characterized in that the particulates are grown on the first surface (1) of the glass with a flame spraying method, laser ablation method and/or chemical vapour deposition.

23. The method according to claim 22, characterized in that convective heating of the first surface (1) of the glass is provided in the flame spraying method with the flame of a liquid flame spray pistol.

24. The method according to any one of claims 17 to 23, characterized in that after the layer (103) of the glass which is close to the first surface (1) has been modified to absorb solar radiation energy, the first surface (1) is coated with a coating (131) that is hydrophilic or becomes hydrophilic due to the effect of solar ultraviolet radiation. 20

25. The method according to claim 24, characterized in that titanium oxide is selected as the agent in the coating (131); and the thickness of the coating is formed to be in the order of less than 100 nm.

26. The method according to any one of claims 17 to 25, characterized in that the second surface (2) of the glass is coated with a low emissivity coating (105, 128) (low-E coating).

27. The method according to claim 26, characterized in that the low emissivity coating (105, 128) is formed on the second surface (2) at the same time as the first surface (1) is being modified to absorb solar radiation energy.

28. The method according to claim 26 or 27, characterized in that the low emissivity coating (105, 128) is formed of transparent conductive oxide.

29. The method according to any one of claims 26 to 28, ch.aracterized in that the low emissivity coating (105, 128) is formed of fluorine-doped tin oxide (SnO₂:F).

30. The method according to claims 26 to 28, characterized in that the low emissivity coating (105, 128) is formed of aluminium-doped zinc oxide (ZnO:Al).

31. The method according to any one of claims 23 to 30, characterized in that the coating (131) that is hydrophilic or becomes hydrophilic due to the effect of solar ultraviolet radiation is formed of the particulates on the first surface (1) with flame spraying method, laser ablation method and/or chemical vapour deposition.

32. The method according to any one of claims 26 to 31, characterized in that the low emissivity coating (105, 128) is formed of the particulates on the second surface (2) with flame spraying method, laser ablation method and/or chemical vapour deposition.

33. The method according to any one of claims 17 to 32, characterized in that after the layer (103) of the glass that is close to the first surface (1) has been modified to absorb solar radiation energy, the glass is tempered.

34. Use of the method according to any of claims 17 to 33
in glass production line (float line),
in glass processing line in which the glass is heated, such as tempering or bending line
in a line that is separated relative to the glass production line and in which the glass is heated.
